(19) United States
(12) Patent Application Publication
(10) Pub. No.: US 2017/0361137 A1
(43) Pub. Date: Dec. 21, 2017

(54) SELF-BRAKING PULLEY

(71) Applicant: AYD LTD., Denbighshire (GB)

(72) Inventor: Stephen GRIFFITHS, Denbighshire (GB)

(21) Appl. No.: 15/628,126

(22) Filed: Jun. 20, 2017

(30) Foreign Application Priority Data
Jun. 21, 2016 (GB) 1610805.2

(51) Int. Cl. A62B 35/00; A62B 35/04; A62B 1/12

(52) U.S. Cl. CPC A62B 35/0093; A62B 1/12; A62B 35/04

(57) ABSTRACT

A self-braking pulley is disclosed for controlling a rate of extraction of a tether coupled with the pulley. The pulley comprises a pulley housing, a spool for receiving a tether, the spool being configured to rotate about a first axis, relative to the pulley housing, and a piston assembly comprising a chamber having a first and second chamber portion which are rotationally locked to the housing. The piston assembly further comprises a fluid disposed within the chamber, a piston which is arranged to move within the chamber along a second axis between the first and second chamber portions and at least one bore formed within the piston for fluidly coupling the first and second chamber portions. The pulley further comprises means for coupling rotational motion of the spool with reciprocating motion of the piston back and forth between the chamber portions, to cause the fluid to transfer between the chamber portions via the at least one bore as the spool rotates.

The present invention relates to a self-braking pulley.

It is well known for individuals working or operating at height to use a tether to secure themselves to a suitable support to arrest their fall should they unexpectedly fall or otherwise need to escape from their position. The tether is typically secured to the individuals harness and as such, while the tether may arrest their fall, there can be a significant jolt upon the individual as the tether becomes taught. Moreover, once the individual has come to a rest and is held suspended from the tether it is necessary to lower the individual to avoid any trauma from prolonged suspension, particularly if the individual is unconscious and held in an inverted orientation.

We have now devised a self-braking pulley, which provides for a controlled extraction of a tether therefrom and thus a controlled descent of an individual coupled to the tether.

In accordance with the present invention there is provided a self-braking pulley for controlling a rate of extraction of a tether coupled with the pulley, the pulley comprising:

a pulley housing;

a spool for receiving a tether, the spool being configured to rotate about a first axis, relative to the pulley housing;

a piston assembly comprising a chamber having a first and second chamber portion which are rotationally locked to the housing, a fluid disposed within the chamber, and a piston which is arranged to move within the chamber along a second axis between the first and second chamber portions, the piston assembly further comprising at least one bore formed within the piston for fluidly coupling the first and second chamber portions,

the pulley further comprising means for coupling rotational motion of the spool with reciprocating motion of the piston back and forth between the chamber portions, to cause the fluid to transfer between the chamber portions via the at least one bore as the spool rotates.

The movement of the piston between the first and second the chamber portions is restricted by the fluid pressure within the chamber portions. In order to relieve the pressure within the chamber portion into which the piston is moving, so that the piston can continue to move toward that chamber portion, the fluid is required to pass along the at least one bore into the other chamber portion. The rate of transfer of fluid and thus the ease with which the pressure can be redistributed, and thus the ease with which the piston can move, is dependent upon the number of bores and a cross-sectional area of the bores, in addition to the viscosity of the fluid. The piston assembly thus serves to brake the rotation of the spool owing to the means for coupling rotational motion of the spool with reciprocating motion of the piston.

In an embodiment, the first axis and the second axis are collinear.

In an embodiment, the means for coupling the rotational movement of the spool with reciprocating motion of the piston comprises at least one follower member which is coupled to the spool, and which extends within an annular channel disposed in an outer surface of the piston, such that as the spool rotates, the follower member is arranged to move along the channel. Preferably, the means for coupling comprises at least two and more preferably three follower members. In an embodiment, the follower members extend radially inwardly of the spool and are equidistantly spaced around the spool.

In an embodiment, the or each follower member comprises a shaft which is coupled at a proximal end thereof to the spool and which comprises a roller disposed at a distal end for facilitating the passage of the respective follower member within the channel.

In an embodiment, the channel comprises a continuous channel which extends circumferentially around the piston, namely a channel which comprises no definitive start or end and where a start and end of the channel coincide. The channel preferably further extends back and forth along the rotational axis, in extending around the rotational axis. The channel preferably follows a harmonically varying path around the piston.

In an embodiment, the spool is arranged to rotate within a bearing arrangement within the housing.

In an embodiment, the piston comprises a first portion and a second portion which separately extend into the first and second chamber portions respectively, in moving back and forth along the second axis. Preferably, the channel extends intermediate the first and second piston portions. In an embodiment, the piston further comprises a first and second seal which extends around the first and second portions respectively, for sealing the first and second piston portions within the first and second chamber portions, respectively.

In an embodiment, the piston comprises at least two bores which extend through the piston. The at least two bores preferably extend along a linear path through the piston. In an embodiment, the at least two bores extend substantially parallel to each other, and preferably parallel to the second axis.

In an embodiment, the piston assembly further comprises at least one connecting rod which couples the first and second chamber portions. The connecting rod extends through a guide bore formed within the piston, such that the piston is arranged to slide upon the connecting rod in moving back and forth between the first and second chamber portions. In an embodiment, the piston assembly comprises at least two connecting rods which extend through a respective guide bore formed within the piston. Preferably, the at least two connecting rods are substantially parallel. The guide rod(s) preferably minimise any rotational motion of the piston about the second axis and restrict the piston to substantially linear motion along the second axis.

In an embodiment, the first and second chamber portions are rotationally locked to the housing via at least a first protuberance and at least a second protuberance, respectively, formed on an outer wall of the respective chamber portion. Preferably, the protuberances extend within a complimentary shaped recess formed within the housing.

Whilst the invention has been described above, it extends to any inventive combination of features set out above or in the following description. Although illustrative embodiments of the invention are described in detail herein with reference to the accompanying drawings, it is to be understood that the invention is not limited to these precise embodiments.

Furthermore, it is contemplated that a particular feature described either individually or as part of an embodiment can be combined with other individually described features, or parts of other embodiments, even if the other features and embodiments make no mention of the particular feature. Thus, the invention extends to such specific combinations not already described.

The invention may be performed in various ways, and, by way of example only, embodiments thereof will now be described, reference being made to the accompanying drawings in which:

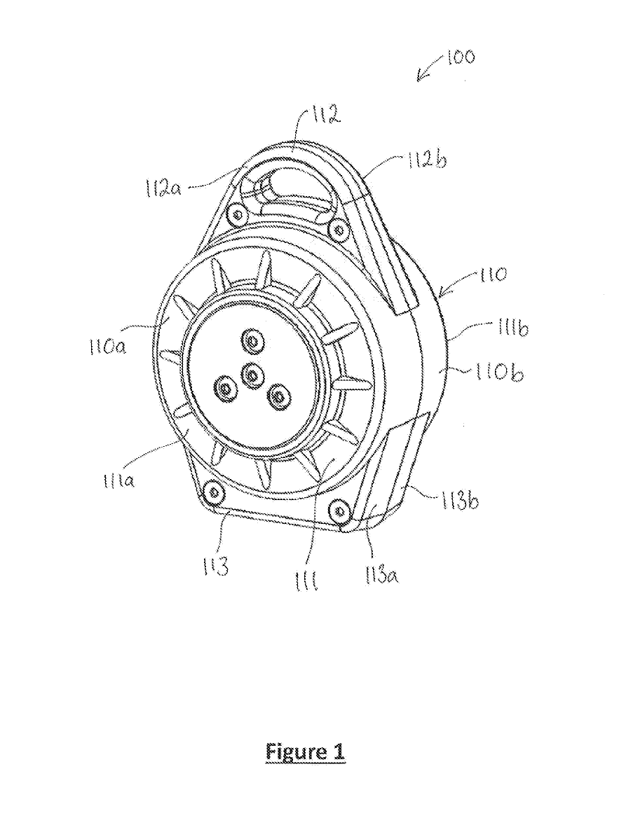

FIG. 1 is a perspective view of a self-braking pulley according to an embodiment of the present invention;

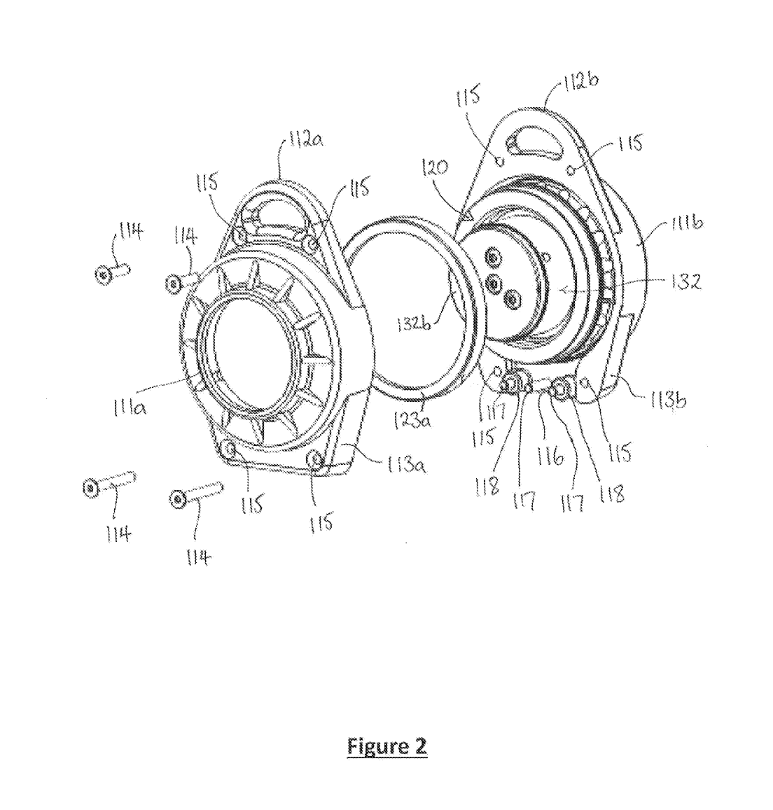

FIG. 2 is a view of the pulley illustrated in FIG. 1, with a front casing removed;

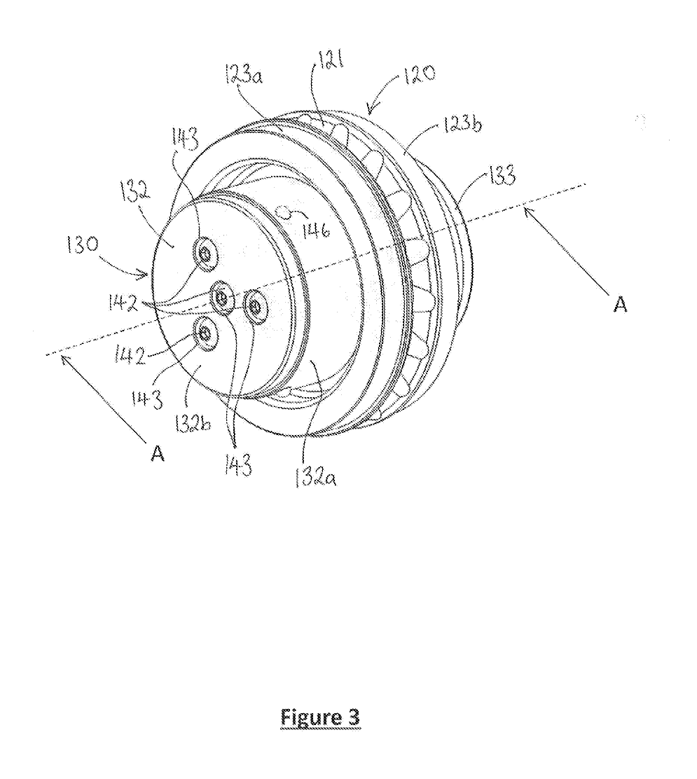

FIG. 3 is a perspective view of the pulley illustrated in FIG. 1, with the housing removed;

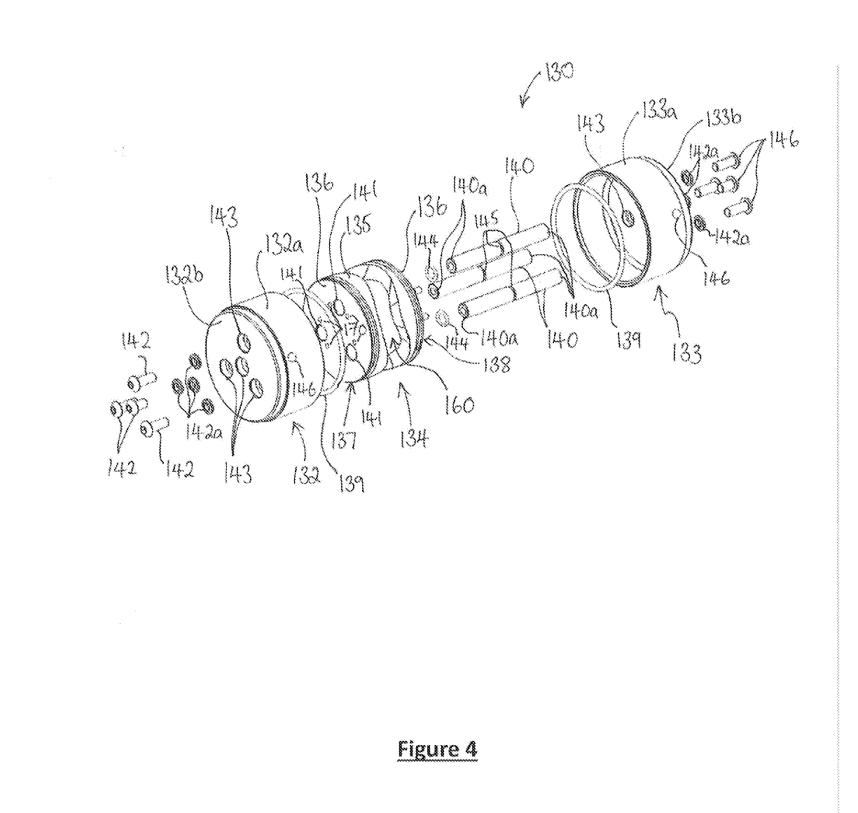

FIG. 4 is an exploded view of the piston assembly;

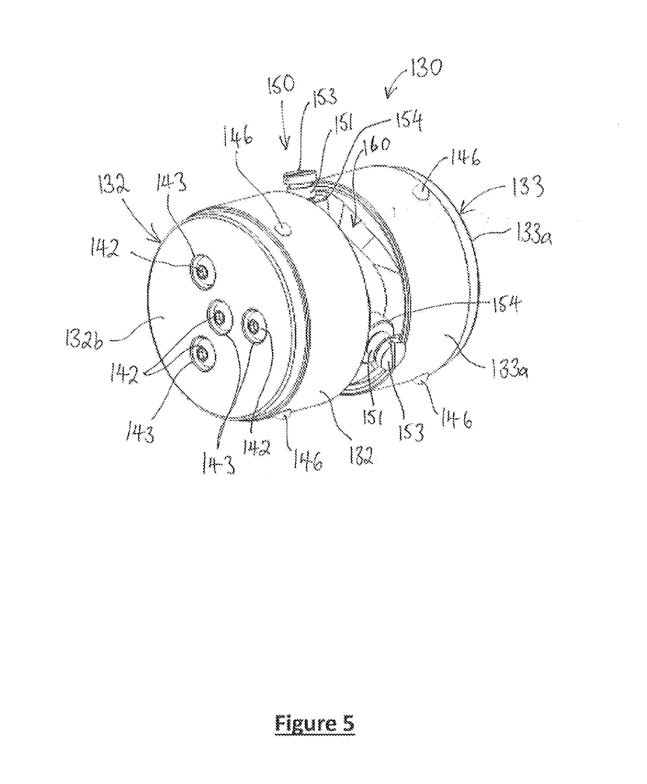

FIG. 5 is an assembled view of the piston assembly illustrated in FIG. 4, with the follower members positioned in situ within the channel;

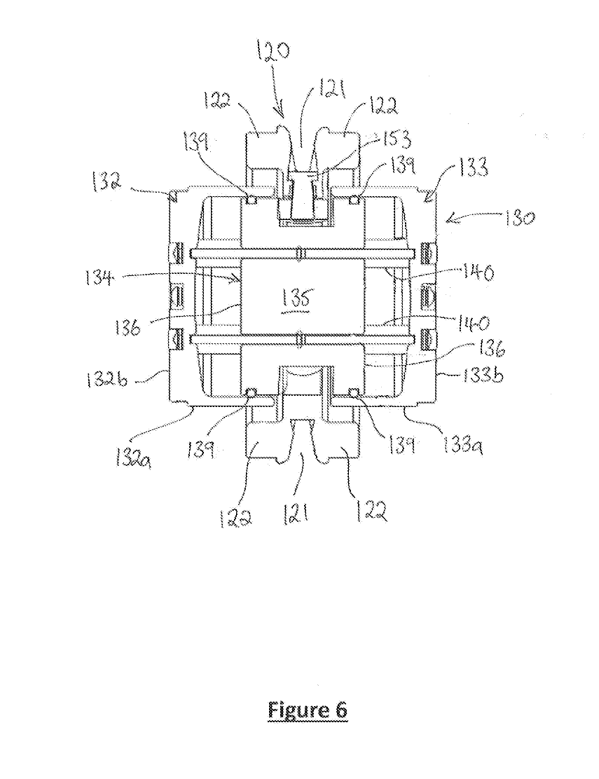

FIG. 6 is a sectional view through the piston assembly of FIG. 3, taken across line A-A, with the bearing elements removed;

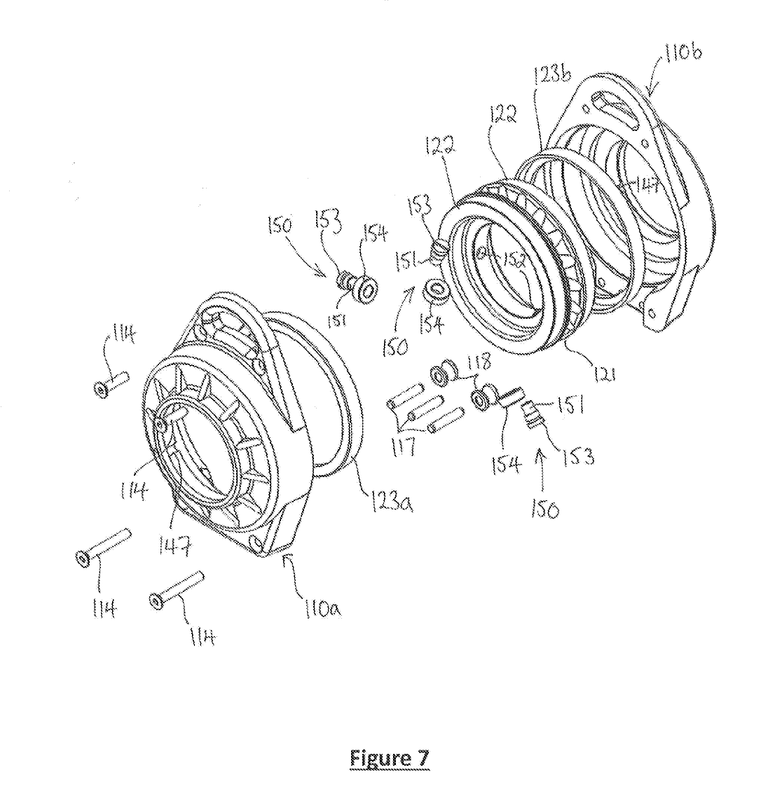

FIG. 7 is an exploded view of the pulley illustrated in FIG. 1 with the piston assembly removed;

Referring to FIGS. 1 and 2 of the drawings, there is illustrated a self braking pulley 100 according to an embodiment of the present invention for controlling a rate of extraction of a tether (not shown) coupled to the pulley 100 for controlling a rate of descent for example, of an individual (not shown) coupled to the tether. The pulley 100 comprises a pulley housing 110 having a front and rear casing 110a, 110b, which may be formed of a rigid plastics or metal alloy, for example. The housing 110 comprises a cylindrical body 111 region orientated such that a longitudinal axis of the body 111 extends substantially horizontally in use. The housing further comprises a handle 112 formed integrally with the body 111, at an upper region thereof, which may also be used for coupling with a karabiner (not shown) or similar for securing the pulley 100 to an anchor position, and a base 113 integrally formed at an underside of the body 111. The front and rear casing 110a, 110b separately comprise a front and rear portion of the handle 112a, 112b, body 111a, 111b and base 113a, 113b, and are coupled together by a plurality of fasteners 114 which are arranged to separately extend through aligned apertures 115 formed in the front and rear casing 110a, 110b.

The pulley 100 further comprises a spool 120 and a piston assembly 130 disposed within the body 111 of the housing 110. The spool 120 is arranged to rotate about a first axis which is substantially collinear with a longitudinal axis of the body 111, and is arranged to receive a tether (not shown), such as a rope (not shown) or webbing (not shown), which may be wound upon the spool 120. A free end of the tether may be rigidly coupled to the spool 120, while the other free end of the tether is arranged to extend out from the housing 110 via an aperture 116 disposed at an underside of the base 113. Alternatively, a tether may be arranged to pass into the housing 110 via the aperture 116, pass around spool 120 and pass out from the housing via the aperture 116. In this respect, the tether may be simply looped around the spool 120, for example. The aperture further comprises a plurality of spacer rods 117 which extend across the aperture 116 and upon which may be disposed rollers 118 which are free to rotate upon the spacer rods for providing a snag free passage of the tether into and out from the pulley housing 110.

Referring to FIGS. 2 and 3 of the drawings, the spool 120 comprises a ring shape having a circumferentially extending recess 121 formed in an outer curved surface thereof, for receiving the tether (not shown). The recess 121 is disposed between opposing annular flanges 122 which are separately receivable in a respective annular bearing element 123a, 123b. The bearing elements 123a, 123b separately extend along an interior curved surface of the front and rear body portions 111a, 111b of the respective casing 110a, 110b, and are coupled thereto, such that the spool 120 can freely rotate within the body 111, but is restricted from moving along the first axis.

Referring to FIGS. 3 and 4 of the drawings, the piston assembly 130 is disposed radially inwardly of the spool 120 and comprises a chamber 131 having a longitudinal or second axis which is coincident with the first axis. The chamber 131 comprises a first and second chamber portion 132, 133, each comprising a cylindrical outer wall 132a, 133a and an end wall 132b, 133b which closes one end of the respective chamber portion 132, 133. The chamber portions 132, 133 are orientated such that the open end of each chamber portion 132, 133 face each other, but are separated from each other along the second axis by a predefined spacing.

The piston assembly 130 further comprises a piston 134 having a substantially cylindrically shaped body 135 which is closed at opposite ends thereof via a respective end wall 136, and which is arranged to move in sliding relation within the chamber 131. In particular, the piston 134 comprises a first piston portion 137 and a second piston portion 138 which are arranged to separately extend in sliding relation within the first and second chamber portions 132, 133, respectively. The first and second portions 137, 138 of the piston 134 separately comprise a circumferentially extending seal 139, such as one or more O-rings, for sealing the outer surface of the body 135 of the first and second piston portions 137, 138 with the inner surface of the cylindrical wall 132a, 133a of the respective chamber portion 132, 133.

The piston 134 and first and second chamber portions 137, 138 are coupled together by at least one connecting rod 140. In the illustrated embodiments, the piston assembly comprises three connecting rods 140 which orientated substantially parallel to each other and the second axis, and which are arranged in a substantially trigonal arrangement. The connecting rods 140 extend through a respective guide bore 141 formed within the piston 134, and the chamber portions 132, 133 are coupled to the rods by passing a fastener 142 through an aperture 143 formed within the end walls 132b, 133b of the chamber portions 132, 133, to couple with an internally threaded portion 140a at the distal ends of the connecting rods 140. The fasteners 142 are sealed within the apertures 143 via respective seal 142a. The piston 134 is arranged to slide in sealing relation, upon the connecting rods 140 via one or more seals 144, such as O-rings, located in an annular recess 145 formed upon the connecting rods 140. The piston 134 is thus limited to substantially linear motion back and forth within the chamber 131, between the chamber portions 132, 133, and the trigonal configuration of the connecting rods 140 further minimises any rotation of the piston 134 within the chamber portions 132, 133.

The first and second chamber portions 132, 133 separately extend to either side of the spool 120, along the first axis, as illustrated in FIGS. 5 and 6 of the drawings. An outer surface of the cylindrical wall 132a, 133a of the chamber portions 132, 133 separately comprise at least one protuberance 146 which extend radially out from the cylindrical wall 132a, 133a and locate within a complimentary shaped recess 147 (as illustrated in FIG. 7 of the drawings) formed within an inner side of the body 111 of the housing 110. In this respect, the first and second chamber portions 132, 133 and thus the piston assembly 130 is rotationally locked to the housing 110, to minimise any rotational movement of the assembly 130 within the housing 110.

The pulley 100 further comprises means for coupling and converting the rotation of the spool 120 with reciprocating motion of the piston 134 back and forth within the chamber portions 132, 133. In the illustrated embodiment, the means comprises three follower members 150 coupled with the spool 120, which are arranged to locate within an annular channel 160 formed in the piston 134. The follower members 150 extend in the plane of the spool 120 and extend into the channel 160 via the spacing between the chamber portions 132, 133. The follower members 150 separately comprise an elongate shaft 151 which is arranged to snap-locate for example, within a respective aperture 152 formed within the spool 120 and which is disposed at a base of the recess 121. The shaft 151 is inserted through the aperture 152 along a radially inward direction of the spool 120, and is prevented from passing completely through the aperture 152 via an oversize shaft head 153. A distal end of the shaft 151 is coupled with a roller 154 or similar for facilitating the passage of the follower member within the annular channel 160 and for centralising the shaft 151 of each member 150 within the channel 160. The follower members 150 are angularly separated equidistantly around the inner periphery of the spool 120, and in the illustrated embodiment comprising three follower members 150, the members 150 are thus angularly separated by substantially 120°.

The channel 160 extends around an outer periphery of the piston 134 and is disposed intermediate the first and second piston portions 137, 138. The channel 160 comprises a continuous channel, having no definitive start or end. The channel 160 extends back and forth along the piston 134, along the first axis, in extending around the axis and comprises a substantially harmonically varying profile. The number of harmonic periods, namely the number of repetition periods of the channel profile in extending back and forth along the first axis, either side of the plane of the spool 120, is configured to comprise one less than the number of follower members 150. This ensures that each follower member 150 experiences the same channel profile at the same time. Accordingly, as the spool 120 rotates about the first axis, the follower members 150 are arranged to rotate with the spool 120.

Referring also to FIG. 7 of the drawings, the movement of the follower members 150 imparts a reciprocating motion of the piston 134 back and forth along the second axis (which in the illustrated embodiment is collinear with the first axis) as the follower members 150 move along the channel 160, owing to the harmonically varying profile of the annular channel 160. The piston assembly 130 further comprises a fluid (not shown), such as an oil or similar, disposed within the first and second chamber portions 132, 133 and the piston 134 further comprises a plurality of bores 170 which extend through the piston body 135. The plurality of bores 170 extend substantially parallel to each other and the second axis, and communicatively couple the chamber portions 132, 133, such that the fluid can transfer between the chamber portions 132, 133 via the plurality of bores 170.

As the spool 120 rotates within the bearing elements 123a, 123b, the piston 134 is arranged to move along the connecting rods 140 toward the first chamber portion 132, for example. During this motion, the end wall 136 of the piston portion 132 will compress the oil disposed between the end wall 136 and the end wall 132b of the first chamber portion 132. This compression will cause the fluid to transfer into the second chamber portion 133 via the plurality of bores 170 within the piston body 135. The speed with which the fluid can pass into the second chamber portion 133 and thus the speed with which the piston 134 can continue to move into the first chamber portion 132 is dependent on the number of bores 170, a cross-sectional area of the bores 170 and the viscosity of the fluid. Similarly, the speed with which the fluid can pass into the first chamber portion 132 and thus the speed with which the piston 134 can continue to move into the second chamber portion 133 on the return stroke, is dependent on the number of bores 170, a cross-sectional area of the bores 170 and the viscosity of the fluid. The piston assembly 130 and fluid thus impart a braking force upon the spool 120, since the reciprocating movement of the piston 134 is coupled to the rotational movement of the spool 120 via the follower members 150 and the piston channel 160. Accordingly, the rate of extraction of a tether (not shown) from the spool 120, and thus a rate of descent of an individual (not shown) from an elevated position, can be suitably controlled by designing a piston 134 with the required number of bores 170, having the required cross-sectional area, in conjunction with the required viscosity of the fluid.

The fluid is arranged to mechanically dampen the motion of the piston 134 and thus in turn, the rotation of the spool 120 by transferring the fluid back and forth between the chamber potions 132, 133. The forced passage of the fluid through the bores 170 is found to generate heat, but this heat is quickly dissipated owing to the thermal conductance of the housing 110.

From the foregoing, it is evident that the self-braking pulley 100 provides an effective means of controlling a rate of rotation of a pulley spool 120.

1. A self-braking pulley for controlling a rate of extraction of a tether coupled with the pulley, the pulley comprising:
a pulley housing;
a spool for receiving a tether, the spool being configured to rotate about a first axis, relative to the pulley housing;
a piston assembly comprising a chamber having a first and second chamber portion which are rotationally locked to the housing, a fluid disposed within the chamber, and
a piston which is arranged to move within the chamber along a second axis between the first and second chamber portions, the piston assembly further comprising at least one bore formed within the piston for fluidly coupling the first and second chamber portions,
the pulley further comprising means for coupling rotational motion of the spool with reciprocating motion of the piston back and forth between the chamber portions, to cause the fluid to transfer between the chamber portions via the at least one bore as the spool rotates.

2. A self-braking pulley according to claim 1, wherein the first axis and the second axis are collinear.

3. A self-braking pulley according to claim 1, wherein the means for coupling the rotational movement of the spool with reciprocating motion of the piston comprises at least one follower member coupled to the spool, which extends within an annular channel disposed in an outer wall of the piston, such that as the spool rotates, the follower member is arranged to move along the channel.

4. A self braking pulley according to claim 3, wherein the at least one follower member extends radially inwardly of the spool.

5. A self-braking pulley according to claim 3, wherein the means for coupling comprises at least two follower members.

6. A self-braking pulley according to claim 5, wherein the follower members are equidistantly spaced around the spool.

7. A self-braking pulley according to claim 3, wherein the or each follower member comprises a shaft which is coupled at a proximal end thereof to the spool and which comprises a roller disposed at a distal end for facilitating the passage of the follower members within the channel.

8. A self-braking pulley according to claim 3, wherein the channel comprises a continuous channel which extends circumferentially around the piston.

9. A self-braking pulley according to claim 3, wherein the channel extends back and forth along the rotational axis, in extending around the rotational axis.

10. A self-braking pulley according to claim 9, wherein the channel follows a harmonically varying path around the piston.

11. A self-braking pulley according to claim 1, wherein the spool is arranged to rotate within a bearing arrangement within the housing.

12. A self-braking pulley according to claim 1, wherein the piston comprises a first portion and a second portion which separately extend into the first and second chamber portions respectively, in moving back and forth along the second axis.

13. A self-braking pulley according to claim 12, as appended to claim 3, wherein the channel extends intermediate the first and second piston portions.

14. A self-braking pulley according to claim 12, wherein the piston further comprises a first and second seal which extends around the first and second portions respectively, for sealing the first and second piston portions within the first and second chamber portions, respectively.

15. A self-braking pulley according to claim 1, wherein the piston comprises at least two bores which extend through the piston.

16. A self-braking pulley according to claim 15, wherein the at least two bores extends along a linear path through the piston.

17. A self-braking pulley according to claim 15, wherein the at least two bores extends substantially parallel to the second axis.

18. A self-braking pulley according to claim 1, wherein the piston assembly further comprises at least one connecting rod which couples the first and second chamber portions.

19. A self-braking pulley according to claim 18, wherein the connecting rod extends through a guide bore formed within the piston, such that the piston is arranged to slide upon the connecting rod in moving back and forth between the first and second chamber portions.

20. A self-braking pulley according to claim 18, wherein the piston assembly comprises at least two connecting rods which extend through a respective guide bore formed within the piston.

21. A self-braking pulley according to claim 20, wherein the at least two connecting rods are substantially parallel.

22. A self-braking pulley according to any of claims 18, wherein the connecting rod or rods minimise any rotational motion of the piston about the second axis and restrict the piston to substantially linear motion along the second axis.

23. A self-braking pulley according to claim 1, wherein the first and second chamber portions are rotationally locked to the housing via at least a first protuberance and at least a second protuberance, respectively, formed on an outer wall of the respective chamber portion.

24. A self-braking pulley according to claim 23, wherein the protuberances extend within a complimentary shaped recess formed within the housing.
